(19) United States
(12) Patent Application Publication
(10) Pub. No.: US 2026/0334719 A1
(43) Pub. Date: Oct. 29, 2026

(54) TAMPING MECHANISM

(71) Applicant: BREVILLE PTY LIMITED, Alexandria, New South Wales (AU)

(72) Inventors: Anthony LADEWIG, Alexandria, New South Wales (AU); Con PSAROLOGOS, Alexandria, New South Wales (AU)

(21) Appl. No.: 19/115,972

(22) PCT Filed: Sep. 22, 2023
(86) PCT No.: PCT/AU2023/050924

§ 371 Date: Mar. 27, 2025

(30) Foreign Application Priority Data
Sep. 29, 2022 (AU) 2022902821

(51) Int. Cl. A47J 31/52; A47J 31/40; A47J 31/42; A47J 31/44

(52) U.S. Cl. CPC A47J 31/5251; A47J 31/40; A47J 31/42; A47J 31/44

(57) ABSTRACT

A tamping mechanism (200) for pressing coffee grounds held by a portafilter into a puck, the tamping mechanism (200) including: a tamp (210) with a tamp face (220) for pressing the coffee grounds; a linkage (230) driven by a shaft (280) and being arranged to move the tamp (210) between a tamp position, wherein the tamp face (220) is pressed in an axial direction (110) with respect to the portafilter during a tamping operation, and a rest position, in which the tamp face (220) is moved at least partially laterally from the tamp position; a motor (290) to drive the shaft (280) of the linkage (230) for movement of the tamp (210) between the tamp position and the rest position; and a controller (300) to control operation of the motor (290).

### RELATED APPLICATIONS

This application claims convention priority from Australian Provisional Patent Application No. 2022902821, the contents of which are incorporated herein in their entirety by reference thereto.

### FIELD

This invention relates to a tamping mechanism, and a coffee machine having the tamping mechanism.

### BACKGROUND

Mechanically assisted tamping mechanisms to compress coffee grounds into a puck for use with a coffee machine to produce a beverage have been contemplated to improve the consistency of tamping pressures applied over a series of tamping operations, and to assist the application of appropriate tamping pressure. However, these tamping mechanisms are typically user-operated, resulting in inconsistent results. Previously contemplated tamping mechanisms require the use of relatively complex linkages and dampening mechanisms to moderate the inconsistent and potentially undesirable forces and speeds used by a user of the tamping mechanism.

An automated tamping mechanism has been previously disclosed that operates on an auger-based mechanism, which causes an undesirable difference in coffee ground packing between a center of a puck and a periphery of the puck, which may cause undesirable channeling during extraction of the beverage. Another automated tamping mechanism has been previously contemplated as a standalone device that uses a rack and pinion gear mechanism to provide vertical translation of a tamp for the tamping operation, however this arrangement can be undesirable for use with a coffee machine.

### SUMMARY

It is an object of the present invention to at least substantially address one or more of the above disadvantages, or at least provide a useful alternative to the above discussed tamping mechanisms.

In a first aspect the present invention provides a tamping mechanism for pressing coffee grounds held by a portafilter into a puck, the tamping mechanism including:
a tamp with a tamp face for pressing the coffee grounds;
a linkage driven by a shaft and being arranged to move the tamp between a tamp position, wherein the tamp face is pressed in an axial direction with respect to the portafilter during a tamping operation, and a rest position, in which the tamp face is moved at least partially laterally from the tamp position;
a motor to drive the shaft of the linkage for movement of the tamp between the tamp position and the rest position; and
a controller to control operation of the motor.

Preferably, the linkage includes a coupling to enable the tamp to rotate relative to the mechanism between the rest and tamp positions.

Preferably, the tamping mechanism further includes a guide structure having a first track, and the tamp includes a pivot to pivotally connect the tamp to the linkage so that the pivot is located between the coupling and the tamp face, the tamp having a first cam to engage the first track such that movement of the tamp is limited by the first track.

Preferably, the linkage includes a recess that is located to engage the first cam as the tamp approaches the tamp position, so that forces are transmissible in the axial direction from the tamp to the linkage through the first cam.

Preferably, the guide structure further includes a second track, and the pivot includes a second cam to engage the second track such that the engagement of the first cam with the first track and the engagement of the second cam with the second track limit movement and orientation of the tamp.

In a second aspect, the present invention provides a coffee machine including the tamping mechanism of the first aspect, the coffee machine having:
a holder for holding the portafilter; and
a grinder for delivering coffee grounds along a flow path to the portafilter, wherein the at least partial lateral movement of the tamp to the rest position, moves the tamp out of the flow path.

Preferably, the linkage includes at least two linkage arms that are connected by a linkage beam, wherein the linkage beam is located a distance from the shaft of the linkage, so as to be out of the flow path when the tamp is in the rest position.

Preferably, the grinder is located vertically above the holder such that the flow path is substantially collinear with the axial direction.

Preferably, the grinder includes a grinder motor for operating the grinder to deliver coffee grounds, wherein the grinder motor includes a grinder motor shaft and the motor of the tamping mechanism includes a tamping motor shaft, wherein the grinder motor shaft and the tamping motor shaft extend in parallel directions.

Preferably, the shaft of the linkage is connected to a linkage gear, and the tamping motor shaft includes a worm gear that engages the linkage gear, such that a high transmission ratio of between 1:20 to 1:100, preferably about 1:50 is achieved from the motor of the tamping mechanism to the shaft of the linkage.

Preferably, the coffee machine further includes a motor speed sensor to provide a tamp speed signal to the controller, the tamp speed signal being indicative of a tamp speed of the tamp face relative to the portafilter, wherein the controller is adapted to:
receive, store, and/or determine a desired tamp speed;
when the tamp speed signal indicates that the tamp speed is below the desired tamp speed, control the power delivered to the motor to increase the tamp speed; and
when the tamp speed signal indicates that the tamp speed is above the desired tamp speed, control the power delivered to the motor to decrease the tamp speed.

Preferably, the coffee machine further includes a motor current sensor to provide a tamp force signal to the controller, the tamp force signal being indicative of a tamp force applied by the tamp face to the coffee grounds, wherein the controller is adapted to:
receive, store, and/or determine a desired tamp force; and
end the tamping operation when the tamp force signal indicates that the tamp force has reached or exceeded the desired tamp force.

Preferably, the coffee machine further includes a motor position sensor to provide a tamp position signal to the controller, the tamp position signal being indicative of a position of the tamp face relative to the portafilter, wherein the controller is adapted to:
receive, store, and/or determine a desired tamp position;
when the tamp force signal indicates that the tamp force has reached or exceeded the desired tamp force, determine a difference between the position indicated by the tamp position signal and the desired tamp position; and
provide an indication of the difference using a user interface.

Preferably, the controller is adapted to adjust a setting of the grinder based on the difference between the position indicated by the tamp position signal and the desired tamp position.

Preferably, the grinder includes a grinder motor for operating the grinder to deliver coffee grounds, and wherein the controller is further adapted to, when the difference between the position indicated by the tamp position signal and the desired tamp position requires more coffee grounds should be delivered:
determine a top-up dose of coffee grounds based on the difference between the position indicated by the tamp position signal and the desired tamp position;
control operation of the grinder motor to deliver the top-up dose of coffee grounds to the portafilter; and
control operation of the tamping mechanism to perform a tamping operation.

Preferably, the holder includes a load cell to provide a weight signal to the controller, the weight signal being indicative of a weight of the portafilter,
wherein the grinder includes a grinder motor for operating the grinder to deliver coffee grounds, and
   wherein the controller is adapted to:
receive, store, and/or determine a desired dosage;
control operation of the grinder motor to deliver coffee grounds to the portafilter;
when the weight signal indicates that the weight of the portafilter has increased by at least the desired dosage, cease operation of the grinder motor; and
control operation of motor of the tamping mechanism to perform a tamping operation.

In a third aspect, the present invention provides a coffee machine for extracting a coffee beverage from coffee grounds in a portafilter, the coffee machine having:
a holder for holding the portafilter; and
a grinder for delivering coffee grounds along a flow path to the portafilter,
a tamping mechanism for pressing coffee grounds held by a portafilter into a puck the tamping mechanism including:
   a tamp with a tamp face for pressing the coffee grounds;
   a linkage driven by a shaft and being arranged to move the tamp between a tamp position, wherein the tamp face is pressed in an axial direction with respect to the portafilter during a tamping operation, and a rest position, in which the tamp face is moved at least partially laterally from the tamp position;
   a user-operated device to drive the shaft of the linkage for movement of the tamp between the tamp position and the rest position,
wherein the at least partial lateral movement of the tamp to the rest position, moves the tamp out of the flow path

### BRIEF DESCRIPTION OF THE DRAWING

Preferred embodiments of the present invention will now be described by way of example, with reference to the accompanying drawings, wherein:

FIG. 1 is an isometric view of a coffee machine according to a preferred embodiment of the present invention.

FIG. 2 is an isometric view of a grinder and tamping mechanism of the coffee machine of FIG. 1 in the tamp position

FIG. 3 is an isometric view of the grinder and tamping mechanism of FIG. 2 in the rest position.

FIG. 4 is a top view of the tamping mechanism of FIG. 2.

FIG. 5 is left side section view of the tamping mechanism along the plane A-A of FIG. 4.

FIG. 6 is a right side view of the tamping mechanism of FIG. 4.

FIG. 7 is a top view of the tamping mechanism of FIG. 3.

FIG. 8 is left side section view of the tamping mechanism along the plane A-A of FIG. 7.

FIG. 9 is a right side view of the tamping mechanism of FIG. 7.

FIG. 10 is a detailed isometric view of the tamping mechanism of FIG. 3.

FIG. 11 is a detailed right side view of the tamping mechanism of FIG. 3.

FIG. 12 is a flow chart showing a weight-based dosage feedback operation of the coffee machine of FIG. 1.

FIG. 13 is a flow chart showing a tamp speed control operation of the coffee machine of FIG. 1.

FIG. 14 is a flow chart showing a tamp force control operation of the coffee machine of FIG. 1.

FIG. 15 is a flow chart showing a position-based dosage feedback operation of the coffee machine of FIG. 1.

### DETAILED DESCRIPTION

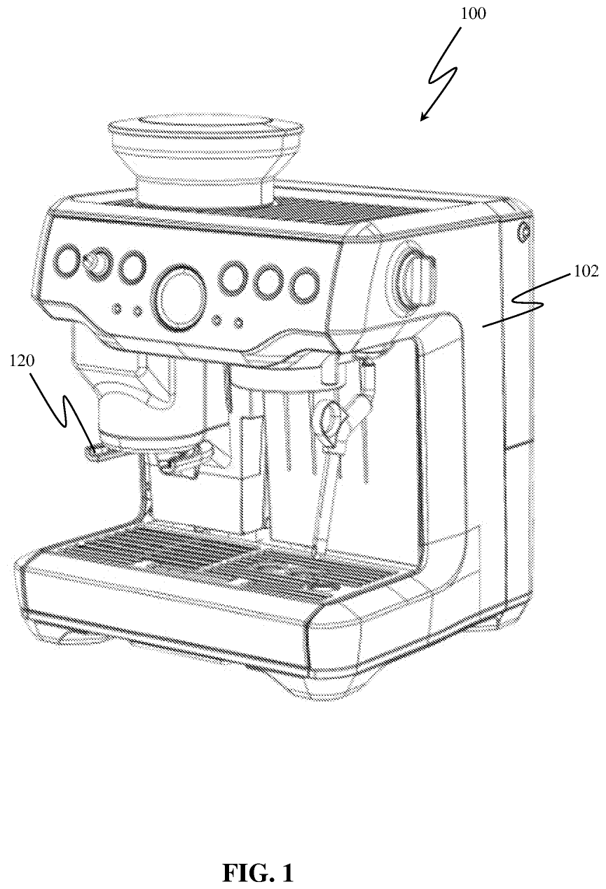

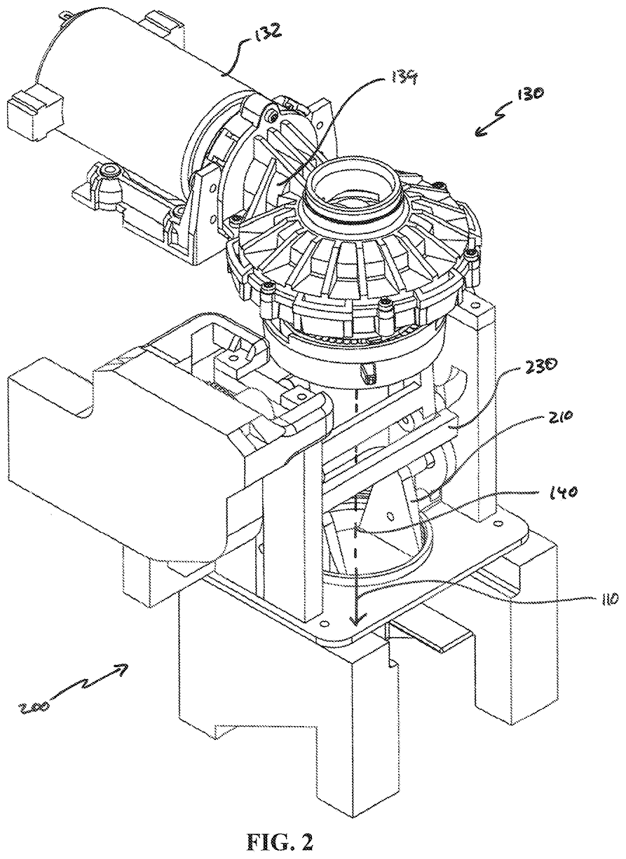

A coffee machine 100 according to a preferred embodiment of the invention, as shown in FIG. 1, includes a body 102 to which a holder 120 for holding a portafilter (not shown) is mounted. Further, as seen in FIG. 2, the coffee machine 100 includes a grinder 130 mounted to the body 102 for delivering coffee grounds along a flow path 140 to the portafilter. The grinder 130 includes a grinder motor 132 for operating the grinder 130 to deliver the coffee grounds, the grinder motor 132 including a grinder motor shaft 134 for delivering torque and/or power to the grinder 130 via a transmission mechanism. The coffee machine 100 also includes a user interface 104 for receiving instructions from a user and/or providing information to the user about operations of the coffee machine 100.

As shown in FIG. 2, the coffee machine 100 further includes a tamping mechanism 200 for pressing coffee grounds held by the portafilter into a puck. The puck is then typically used by the coffee machine 100 for extracting a beverage from the coffee grounds, however this step is not the subject of this specification and many approaches to extract a coffee beverage from a puck of coffee grounds are known in the art.

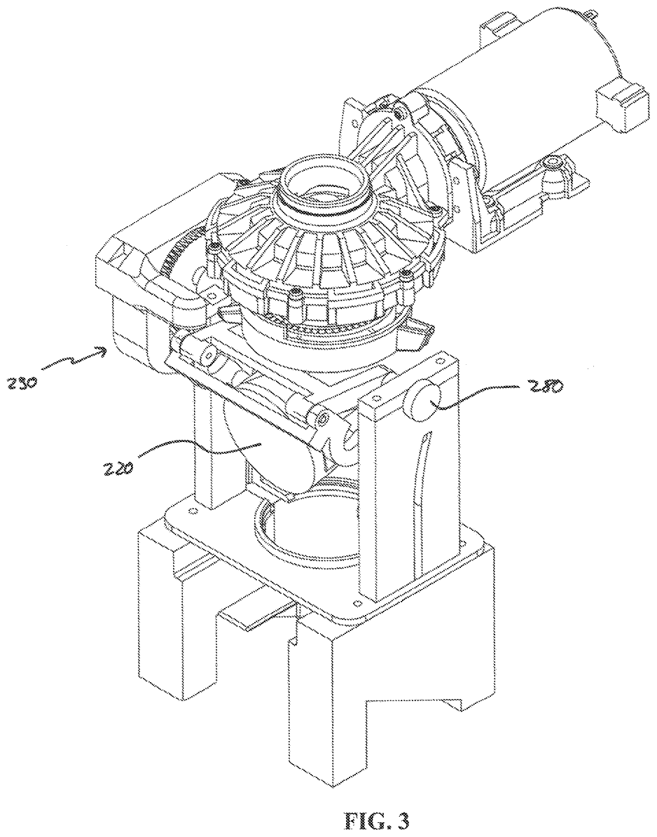

Remaining with FIG. 2, the tamping mechanism 200 includes a tamp 210 having a tamp face 220 for pressing the coffee grounds. The tamp face 220 is preferably flat, and preferably circular to conform to the opening of a filter basket held by the portafilter to which the coffee grounds are delivered by the grinder 130. The tamping mechanism further includes a linkage 230 arranged to move the tamp 210 between a tamp position, shown in FIG. 2, and a rest position, shown in FIG. 3. In a preferred embodiment, the linkage 230 is a slider-crank mechanism. In the tamp position, the tamp face 220 is pressed in an axial direction 110 with respect to the portafilter during a tamping operation. In the rest position, shown in FIG. 3, the tamp face 220 is moved at least partially laterally from the tamp position. As shown in FIG. 8, the at least partial lateral movement of the tamp 210 to the rest position moves the tamp 210 out of the flow path 140. The linkage 230 is driven by a shaft 280 and also includes a motor 290 to drive the shaft 280 of the linkage 230 for movement of the tamp 210 between the tamp position and the rest position. Yet further, the tamping mechanism 200 includes a controller 300 to control operation of the motor 290. In another embodiment, the linkage 230 may be driven by a manual mechanism (not shown), such as a lever, dial, or other user-operated motion mechanism.

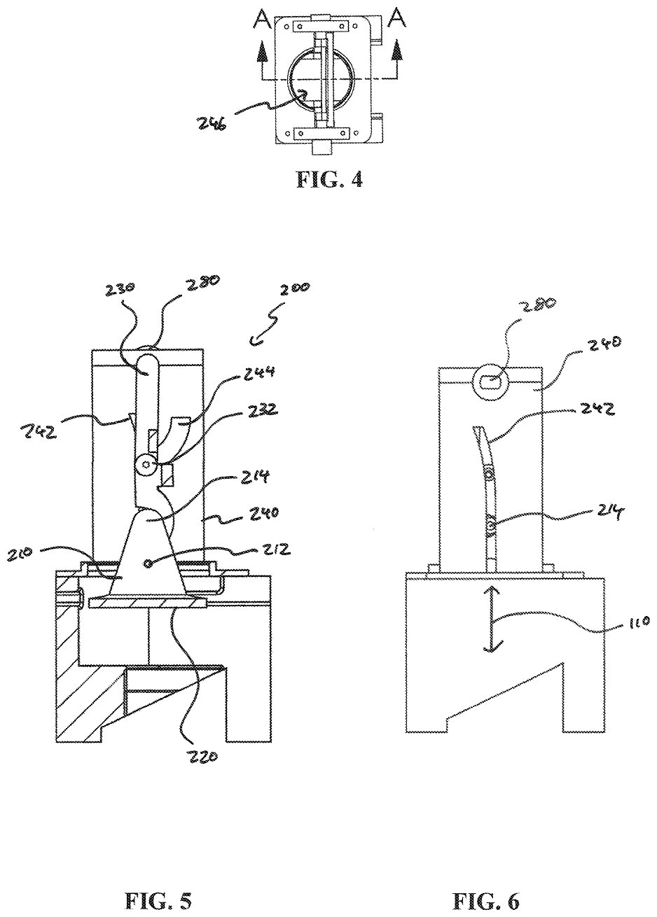

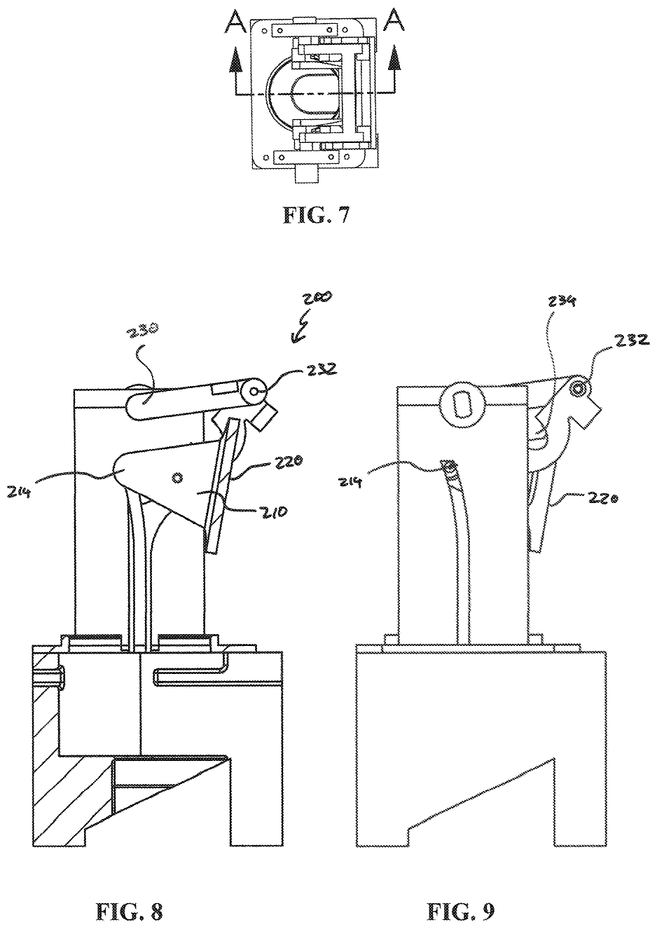

Moving now to FIGS. 4 to 6, which show the tamping mechanism 200 in the tamp position, and FIGS. 7 to 9, which show the tamping mechanism 200 in the rest position, the linkage 230 includes a coupling 232 to enable the tamp 210 to rotate relative to the tamping mechanism 200 between the rest and tamp positions. The coupling 232 is preferably located between the tamp 210 and the shaft 280. The tamping mechanism further includes a guide structure 240 having a first track 242. The guide structure 240 also defines a channel 246 within which the flow path 140 by which the coffee grounds are delivered by the grinder 130 is located. The tamp 210 includes a pivot 212 to pivotally connect the tamp 210 to the linkage 230 so that the pivot 212 is located between the coupling 232 and the tamp face 220. The tamp also has a first cam 214 to engage the first track 242, such that movement of the tamp 210 is limited by the first track 242, as shown in FIGS. 6 and 9.

As best seen in FIG. 9, the linkage 230 includes a recess 234 that is located to allow the recess 234 to engage the first cam 214 as the tamp 210 approaches the tamp position, as best shown in FIG. 2. The recess 234 thus provides sufficient space for the linkage 230 to be located along the axial direction 110 when force is applied to the tamp 210 during the tamping operation. In this way, forces are transmissible in the axial direction 110 from the tamp 210 to the linkage 230 through the first cam 214. Further, this arrangement allows the shaft 280, coupling 232, and pivot 212 to be substantially aligned and/or collinear in the axial direction 110.

As best seen in FIG. 5, the guide structure 240 optionally further includes a second track 244. The second track 244 is preferably shallower than the first track 242, most preferably, the first track 242 is a through slot, while the second track 244 is a groove. The pivot 212 of the tamp 210 includes a second cam 216 to engage the second track 244 such that the engagement of the first cam 214 with the first track 242 and the engagement of the second cam 216 with the second track 244 limits movement and orientation of the tamp 210 as it moves between the tamp position and the rest position. Preferably, as seen in FIG. 5, the second track 244 is displaced generally horizontally from the first track 242 at a position corresponding to the rest position of the tamp 210, such that the tamp 210 is rotated in the rest position, relative to the tamp position. Thus, the second track 244 defines the rotational movement of the tamp 210 as it moves to and from the rest position. As a result, the second track 244 is a spirograph of the movement of the tamp 210 relative to the first track 242.

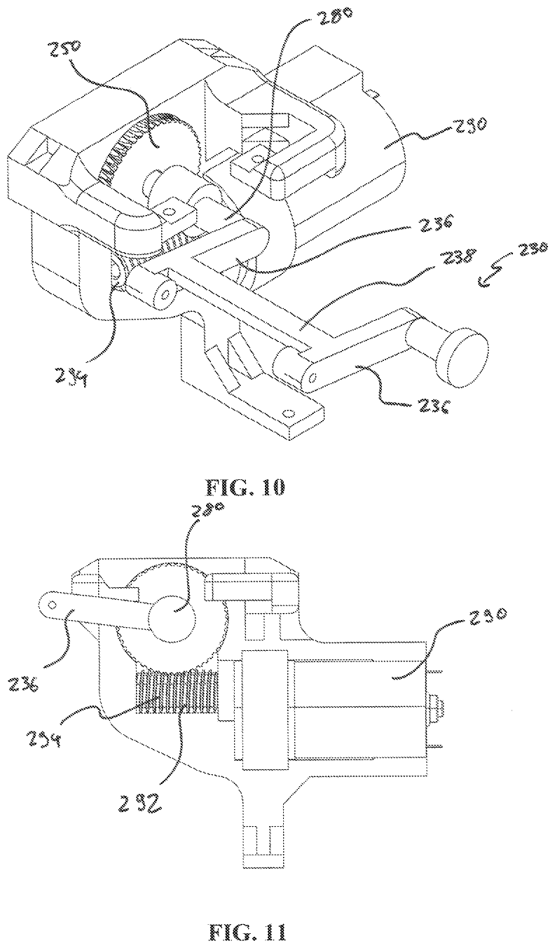

Moving now to FIG. 10, the linkage 230 further includes at least two linkage arms 236 that are connected by a linkage beam 238. The linkage beam 238 is located a distance 252 from the shaft 280 of the linkage 230, so that the linkage beam 238 is out of the flow path 140 when the tamp 210 is in the rest position. As can also be seen in FIG. 10, the motor 290 operating the tamping mechanism 200 includes a transmission mechanism that may include a tamping motor shaft 292, and as best seen in FIG. 11, the tamping motor shaft 292 includes a worm gear 294. However, other transmission mechanisms such as gears or belt systems could also be used. The worm gear 294 engages a linkage gear 250 attached to the shaft 280 of the linkage 230, to provide a transmission ratio of between 1:20 to 1:100, preferably about 1:50 between the motor 290 and the shaft 280. The transmission ratio may vary depending on the type of motor, the target tamp force, and the dimensions of the linkage in the particular application.

Returning now to FIG. 2, which shows that the grinder 130 is located vertically above the holder 120, such that the flow path 140 along which coffee grounds are delivered to the portafilter, is substantially collinear with the axial direction 110. Preferably, the tamping motor shaft 292 and the grinder motor shaft 134 extend in parallel directions. The grinder motor 132 may be operated by the controller 300 according to a set of grinder settings including, for example, a time for which the grinder 130 is operated to deliver an amount of coffee grounds and/or a grind size setting.

Finally, the coffee machine 100 may include a motor speed sensor (not shown), such as a positional encoder that can be kinematically differentiated or inductive speed sensor, to provide a tamp speed signal to the controller 300. The tamp speed signal can be determined by the controller 300 to be indicative of a tamp speed of the tamp face 220 relative to the portafilter, based on the geometry of the tamping mechanism 200. The coffee machine 100 may include a motor current sensor (not shown), such as a known resistor across which voltage can be measured, to provide a tamp force signal to the controller 300. The tamp force signal can be determined by the controller 300 to be indicative of a tamp force applied by the tamp face 220 to the coffee grounds, based on the geometry of the tamping mechanism 200, and the specifications of the motor 290. The coffee machine 100 may include a motor position sensor (not shown), such as an optical or electrical positional encoder or inductive speed sensor that can be kinematically integrated, to provide a tamp position signal to the controller 300. The controller 300 can determine the tamp position signal to be indicative of a position of the tamp face 220 relative to the portafilter, based on the geometry of the tamping mechanism 200. In a preferred embodiment, the holder 120 includes a load cell (not shown) to provide a weight signal to the controller 300. The weight signal 300 can be determined by the controller 300 to be indicative of a weight of the portafilter.

The controller 300 may further be adapted to determine the motor torque required to exert a desired tamp force F at the tamp face 220. The linkage 230 include a first linkage member extending from the shaft 280 (point A) to the pivot 232 (point B), and a second linkage member that extends from the pivot 232 (point B) to the tamp 210 (point C). A torque Mc is applied at point A, point B and point C are pivoted connections. Taking the forces at each point to be Aₓ, A_{y}, Bₓ, B_{y}, Cₓ, C_{y}:

$$\begin{matrix}F = {A}_{y} = {B}_{y} , {A}_{x} = {B}_{x} \\ ( Clockwise + ) \sum {M}_{b} = 0 , {A}_{y} ( {l}_{1} sin θ ) - {A}_{x} ( {l}_{1} cos θ ) = 0 \\ ∴ {A}_{x} = F tan θ\end{matrix}$$

$$and$$

$$\begin{matrix}F = {B}_{y} = {C}_{y} , {A}_{x} = {B}_{x} = {C}_{x} \\ ( Clockwise + ) \sum {M}_{c} = 0 , {M}_{c} - {A}_{x} ( {l}_{2} cos θ ) - F ( {l}_{2} sin θ ) = 0 \\ {M}_{c} = Ax ( {l}_{2} cos θ ) + F ( {l}_{2} sin θ ) \\ = ( F tan θ ) ( {l}_{2} cos θ ) + F ( {l}_{2} sin θ ) \\ ∴ {M}_{c} = 2 * F * l sin θ\end{matrix}$$

Where θ is the angle between the linkage 220 and the axial direction 110, and lₙ is the length of linkage member n. In the preferred embodiment, the first and second linkage members are of equal length.

Use of the coffee machine 100 will now be discussed.

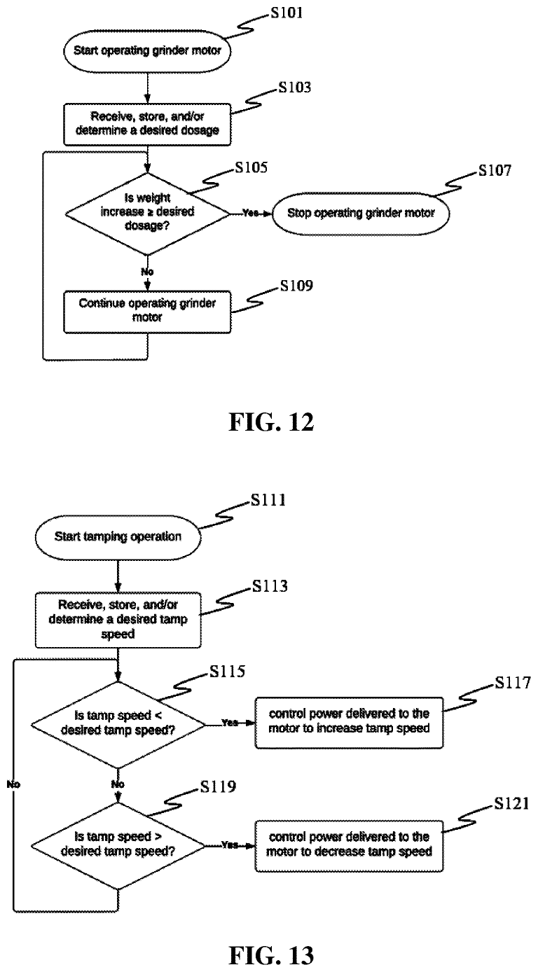

As shown in FIG. 12, upon receiving instructions from the user via the user interface 104, the controller 300, at step S101, operates the grinder motor 132 to deliver coffee grounds along the flow path 140 to the portafilter. Preferably, the tamping mechanism 200 is in the rest position, such that the flow path 140 is unobstructed by the linkage 230 and the tamp 210. In the embodiment where the holder 120 includes the load cell, as shown in FIG. 12, the controller 300, at step S103, receives from the user via the user interface 104, or has stored, or determines from known information, a desired dosage of coffee grounds to be delivered by the grinder 130. At step S105, the controller 300 compares the increase in weight of the portafilter, using the weight signal. When the weight signal indicates that the weight of the portafilter has increased by at least the desired dosage, at step S107, the controller 300 ceases operation of the grinder motor 132. Otherwise, as shown in step S109, the controller 300 continues operating the grinder motor 132. In embodiments without the load cell, the controller 300 ceases operation of the grinder motor 132 once the time setting for the grinder 130 has elapsed.

As shown in FIGS. 13 to 15, the controller 300 then, at step S111, starts the tamping operation by controlling the motor 290 to move the tamp 210 from the rest position toward the tamp position.

FIG. 13 shows a tamp speed control operation that the coffee machine 100 may perform if it has the motor speed sensor.

At step S113, the controller 300 receives from the user via the user interface 104, or has stored, or determines from known information, a desired tamp speed. The desired tamp speed may include a desired tamp speed profile that changes with the position of the tamp 210 along the tracks 242, 244 between the rest position and the tamp position. The desired tamp speed may be different for movement of the tamp 210 from the rest position to the tamp position, and movement from the tamp position back to the rest position. While controller 300 operates the motor 290 to move the tamp 210 from the rest position toward the tamp position, at step S115, the controller 300 determines whether the tamp speed, as indicated by the tamp speed signal, is below the desired tamp speed. When the tamp speed signal indicates that the tamp speed is below the desired tamp speed, at step S117, the controller 300 controls the power delivered to the motor 290 to increase the tamp speed. At step S119, the controller 300 determines whether the tamp speed, as indicated by the tamp speed signal, is above the desired tamp speed. When the tamp speed signal indicates that the tamp speed is above the desired tamp speed, at step S121, the controller 300 controls the power delivered to the motor 290 to increase the tamp speed.

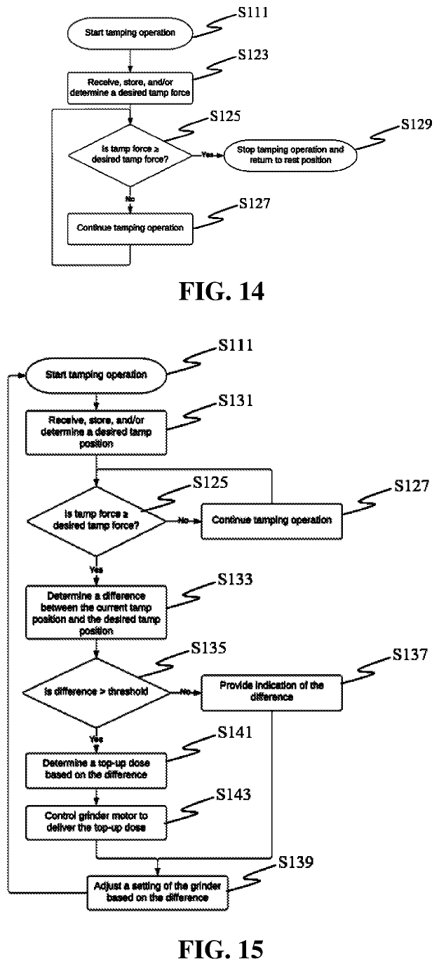

FIG. 14 shows a tamp force control operation that the coffee machine 100 may perform if it has the motor current sensor.

At step S123, the controller 300 receives from the user via the user interface 104, or has stored, or determines from known information, a desired tamp force. While the controller 300 operates the motor 290 to move the tamp 210 from the rest position toward the tamp position, at step S125, the controller 300 compares the tamp force, based on the tamp force signal, to the desired tamp force. When the tamp force signal indicates that the tamp force has reached or exceed the desired tamp force, at step S129, the controller 300 ends the tamping operation and controls the motor 290 to return the tamp 210 to the rest position. Otherwise, at step S127, the controller 300 continues the tamping operation.

FIG. 15 shows a position-based dosage feedback operation that the coffee machine 100 may perform if it has the motor position sensor.

At step S131, the controller 300 receives from the user via the user interface 104, or has stored, or determines from known information, a desired tamp position. When step S125 has been performed above and the controller 300 has determined that the tamp force has reached or exceeded the desired tamp force, the controller, at step S133, determines a difference between the current tamp position, based on the tamp position signal, and the desired tamp position. At step S133, the controller 300 determines whether the difference indicates that more coffee grounds should be delivered, to provide a desirable dose of coffee grounds in the portafilter. If no further coffee grounds are required, or the difference indicates that too many coffee grounds have been delivered, the controller 300 provides an indication, at step S137, of the difference using the user interface 104. Further, in some embodiments that include step S139, the controller 300 may adjust one or more settings of the grinder 130 based on the difference between the position indicated by the tamp position signal and the desired tamp position, so that a future operation of the grinder 130 according to the updated settings, and subsequent tamping operation, will result in a smaller difference between the tamp position and the desired tamp position.

If further coffee grounds are required, the controller 300, at step S141, determines a top-up dose based on the difference between the position indicated by the tamp position signal, and the desired tamp position. The controller 300 may also, in some embodiments, provide the indication of step S137 using the user interface 104, and await confirmation to proceed with the top-up dose from the user. The controller 300 then, at step S143, controls the grinder motor 132, to deliver the top-up dose. Step S139, as explained above, may also be performed to adjust future operations of the grinder 130. Finally, the controller 300 returns to step S111 to perform the tamping operation to press the coffee grounds of the top-up dose into the puck.

Advantages of the coffee machine 100 will now be discussed.

Because the motor-driven linkage 230 operates to move the tamp face 220 at least partially laterally from the tamp position, the flow path 140 is substantially unimpeded, and the grinder 130 may be positioned substantially vertically above the holder 110, eliminating the need for a grind chute. The rotation of the tamp 210 between the rest and tamp positions moves the tamp 210 from the flow path 140 using a linkage 230 with a small geometric footprint. The use of the first track 242 to limit movement of the tamp 210, provides protection against jamming or buckling of the linkage 230. The use of the first cam 214 and the recess 234 allows for an efficient force path from the tamp face 220 to the shaft 280. The use of the second track 244 provides for secure control over orientation of the tamp 210.

The parallel extension of the tamping motor shaft 292 and the grinder motor shaft 134 allows for efficient packaging of the tamping mechanism 200 and grinder 130 within the coffee machine 100. The use of the worm gear 294 provides for a desirably high transmission ratio that allows a relatively low-torque motor 290 to be used.

The use of the motor current sensor allows control of the tamp force using the controller 300, rather than mechanical parts, such as dampeners and/or springs, which decreases the mechanical complexity of the tamping mechanism 200. The use of the motor position sensor allows for a position-based dosage feedback algorithm, that can continuously adjust the settings of the grinder 130 to adjust the amount of coffee grounds being delivered to the portafilter. The indication of the difference between the tamp position and the desired tamp position allows the user to make desirable adjustments to the grinder settings, or other operating parameters of the coffee machine, to result in a smaller difference in future tamping operations. The use of the difference between the tamp position and the desired tamp position to deliver a top-up dose of coffee grounds, allows an adjustment of the delivered dose to be closer to the desired dose, without discarding the already delivered coffee grounds. The use of the load cell to provide the weight signal allows a weight-based dosage feedback that occurs before the tamping operation is commenced, which is desirable as multiple tamping operations can result in fracturing of the puck, or other inconsistencies in coffee density throughout the puck that lead to undesirable channeling.

Persons skilled in the art will understand that this specification disclosed various features in in various combinations, but that the features may be combined with each other in different desirable combinations, depending on the design specification of a particular device. It will be appreciated that the disclosure of this specification also extends to these other, easily derivable, combinations.

1. A tamping mechanism for pressing coffee grounds held by a portafilter into a puck, the tamping mechanism including:
a tamp with a tamp face for pressing the coffee grounds;
a linkage driven by a shaft and being arranged to move the tamp between a tamp position, wherein the tamp face is pressed in an axial direction with respect to the portafilter during a tamping operation, and a rest position, in which the tamp face is moved at least partially laterally from the tamp position;
a motor to drive the shaft of the linkage for movement of the tamp between the tamp position and the rest position; and
a controller to control operation of the motor.

2. The tamping mechanism of claim 1, wherein the linkage includes a coupling to enable the tamp to rotate relative to the mechanism between the rest and tamp positions.

3. The tamping mechanism of claim 2, wherein the tamping mechanism further includes a guide structure having a first track, and the tamp includes a pivot to pivotally connect the tamp to the linkage so that the pivot is located between the coupling and the tamp face, the tamp having a first cam to engage the first track such that movement of the tamp is limited by the first track.

4. The tamping mechanism of claim 3, wherein the linkage includes a recess that is located to engage the first cam as the tamp approaches the tamp position, so that forces are transmissible in the axial direction from the tamp to the linkage through the first cam.

5. The tamping mechanism of claim 3, wherein the guide structure further includes a second track, and the pivot includes a second cam to engage the second track such that the engagement of the first cam with the first track and the engagement of the second cam with the second track limit movement and orientation of the tamp.

6. A coffee machine including the tamping mechanism of any one of claims 1 to 5, the coffee machine having:
a holder for holding the portafilter; and
a grinder for delivering coffee grounds along a flow path to the portafilter,
wherein the at least partial lateral movement of the tamp to the rest position, moves the tamp out of the flow path.

7. The coffee machine of claim 6, wherein the linkage includes at least two linkage arms that are connected by a linkage beam, wherein the linkage beam is located a distance from the shaft of the linkage, so as to be out of the flow path when the tamp is in the rest position.

8. The coffee machine of claim 6, wherein the grinder is located vertically above the holder such that the flow path is substantially collinear with the axial direction.

9. The coffee machine of claim 6, wherein the grinder includes a grinder motor for operating the grinder to deliver coffee grounds, wherein the grinder motor includes a grinder motor shaft and the motor of the tamping mechanism includes a tamping motor shaft, wherein the grinder motor shaft and the tamping motor shaft extend in parallel directions.

10. The coffee machine of claim 9, wherein the shaft of the linkage is connected to a linkage gear, and the tamping motor shaft includes a worm gear that engages the linkage gear, such that a high transmission ratio of between 1:10 to 1:100, preferably about 1:50 is achieved from the motor of the tamping mechanism to the shaft of the linkage.

11. The coffee machine of claim 6, wherein the coffee machine further includes a motor speed sensor to provide a tamp speed signal to the controller, the tamp speed signal being indicative of a tamp speed of the tamp face relative to the portafilter, wherein the controller is adapted to:
receive, store, and/or determine a desired tamp speed;
when the tamp speed signal indicates that the tamp speed is below the desired tamp speed, control the power delivered to the motor to increase the tamp speed; and
when the tamp speed signal indicates that the tamp speed is above the desired tamp speed, control the power delivered to the motor to decrease the tamp speed.

12. The coffee machine of claim 6, wherein the coffee machine further includes a motor current sensor to provide a tamp force signal to the controller, the tamp force signal being indicative of a tamp force applied by the tamp face to the coffee grounds, wherein the controller is adapted to:
receive, store, and/or determine a desired tamp force; and
end the tamping operation when the tamp force signal indicates that the tamp force has reached or exceeded the desired tamp force.

13. The coffee machine of claim 12, wherein the coffee machine further includes a motor position sensor to provide a tamp position signal to the controller, the tamp position signal being indicative of a position of the tamp face relative to the portafilter, wherein the controller is adapted to:
receive, store, and/or determine a desired tamp position;
when the tamp force signal indicates that the tamp force has reached or exceeded the desired tamp force, determine a difference between the position indicated by the tamp position signal and the desired tamp position; and
provide an indication of the difference using a user interface.

14. The coffee machine of claim 13, wherein the controller is adapted to adjust a setting of the grinder based on the difference between the position indicated by the tamp position signal and the desired tamp position.

15. The coffee machine of claim 13, wherein the grinder includes a grinder motor for operating the grinder to deliver coffee grounds, and wherein the controller is further adapted to, when the difference between the position indicated by the tamp position signal and the desired tamp position requires more coffee grounds should be delivered:
determine a top-up dose of coffee grounds based on the difference between the position indicated by the tamp position signal and the desired tamp position;
control operation of the grinder motor to deliver the top-up dose of coffee grounds to the portafilter; and
control operation of the tamping mechanism to perform a tamping operation.

16. The coffee machine of claim 6, wherein the holder includes a load cell to provide a weight signal to the controller, the weight signal being indicative of a weight of the portafilter,
wherein the grinder includes a grinder motor for operating the grinder to deliver coffee grounds, and
wherein the controller is adapted to:
receive, store, and/or determine a desired dosage;
control operation of the grinder motor to deliver coffee grounds to the portafilter;
when the weight signal indicates that the weight of the portafilter has increased by at least the desired dosage, cease operation of the grinder motor; and
control operation of motor of the tamping mechanism to perform a tamping operation.

17. A coffee machine for extracting a coffee beverage from coffee grounds in a portafilter, the coffee machine having:
a holder for holding the portafilter; and
a grinder for delivering coffee grounds along a flow path to the portafilter,
a tamping mechanism for pressing coffee grounds held by a portafilter into a puck the tamping mechanism including:
a tamp with a tamp face for pressing the coffee grounds;
a linkage driven by a shaft and being arranged to move the tamp between a tamp position, wherein the tamp face is pressed in an axial direction with respect to the portafilter during a tamping operation, and a rest position, in which the tamp face is moved at least partially laterally from the tamp position;
a manually operated device to drive the shaft of the linkage for movement of the tamp between the tamp position and the rest position,
wherein the at least partial lateral movement of the tamp to the rest position, moves the tamp out of the flow path

18. The coffee machine of claim 17, wherein the linkage includes at least two linkage arms that are connected by a linkage beam, wherein the linkage beam is located a distance from the shaft of the linkage, so as to be out of the flow path when the tamp is in the rest position.

19. The coffee machine of claim 17, wherein the grinder is located vertically above the holder such that the flow path is substantially collinear with the axial direction.
